(19) United States
(12) Patent Application Publication
(10) Pub. No.: US 2015/0378025 A1
(43) Pub. Date: Dec. 31, 2015

(54) Multipath Detection for Global Positioning System

(71) Applicant: Mitsubishi Electric Research Laboratories, Inc., Cambridge, MA (US)

(72) Inventors: Kyeong Jin Kim, Lexington, MA (US); Okuary Osechas, Cambdirge, MA (US); Zafer Sahinoglu, Cambridge, MA (US); Kieran Parsons, Cambridge, MA (US)

(21) Appl. No.: 14/318,832

(22) Filed: Jun. 30, 2014

(51) Int. Cl. G01S 19/22; G01S 19/03

(52) U.S. Cl. CPC G01S 19/22; G01S 19/03

(57) ABSTRACT

A satellite navigation system includes a first Global Navigation Satellite System (GNSS) receiver for determining a first value of a parameter of a GNSS signal and a second GNSS receiver for determining a second value of the parameter of the GNSS signal. The first GNSS receiver is rigidly connected to the second GNSS receiver. The GNSS also includes a processor for comparing the first value of the parameter with the second value of the parameter to detect a multipath of the GNSS signal.

### FIELD OF THE INVENTION

This invention relates generally to the global navigation satellite system (GNSS), and more particularly to detection of multipath GNSS signals.

### BACKGROUND OF THE INVENTION

The global navigation satellite system (GNSS) is a satellite navigation system that provides location and time information with line-of-sight (LOS) to four or more GNSS satellites. Examples or subsystems of the GNSS include a Global Positioning System (GPS), a Wide Area Augmentation System (WAAS), a Quasi-Zenith Satellite System (QZSS), a Multi-functional. Satellite Augmentation System (MSAS), a Galileo, and a Glonass. In an urban environment, reflection and refraction of the LOS GNSS signals can lead to multipath GNSS signals affecting the accuracy of position estimates.

Conventional GNSS systems use temporal and spatial diversity to minimize problems with multipath GNSS signals. The temporal methods use differences in time delays between the multipath signals and the LOS signal. However, those methods are computationally complex and ineffective when the delays of the multipath signals are short.

The spatial methods use multiple antennas for multipath detection and mitigation. For example, the method described in U.S. Pat. No. 7,642,957 uses two antennas to receive GNSS signal in a hope that at least one antenna receives a “good” GNSS signal resulted from constructively interfered GNSS signals. However, the constructive interference of GNSS signals cannot be guaranteed, and all antennas of such a GNSS system can be subject to the same multipath degradation. In addition, in a number of GNSS applications, the usage of multiple antennas is undesirable.

Accordingly, there is still a need for a method that detects multipath GNSS signals.

### SUMMARY OF THE INVENTION

In satellite navigation applications, GNSS signals received by GNSS receivers can be characterized by various parameters, such as strength of the GNSS signal and/or frequency of the GNSS signal. The parameters of the received GNSS signals depend on the movement of the GNSS receivers with respect to GNSS satellites. For example, the parameters of the GNSS signals determined by GNSS receivers with similar locations but different velocity are likely to be different.

Also, parameters of the GNSS signals depend on reflections of the signal by features in the environment, such as buildings, trees, or the terrain, which can lead to multipath GNSS signals. The multipath GNSS signals affect the parameters of the received GNSS signal. Usually, similarly located GNSS receivers are similarly affected by the multipath.

Some embodiments of the invention are based on a realization that when multiple GNSS receivers move with the substantially identical velocity and are sufficiently spaced apart, the values of the parameters of the GNSS signals received by those spatially separated GNSS receivers can be used to detect the multipath. For example, if parameters of the GNSS signals received by those spatially separated GNSS receivers are similar, then it is more likely that none of the spatially separated GNSS receivers experience multipath than all spatially separated GNSS receivers experience the same multipath. Therefore, by comparing parameters of the GNSS signals received by multiple GNSS receivers having identical velocity, the presence of multipath can be detected when a parameter of a GNSS signal received by one GNSS receiver differs from a parameter of the GNSS signal received by another GNSS receiver.

Usually, it is difficult or impractical to have sufficiently separated GNSS receivers moving with the identical velocity. However, some embodiments of the invention are based on recognition that multiple GNSS receivers rigidly arranged on the same moving object, e.g., a vehicle, robot aircraft, or vessel, satisfy the velocity constraint. For example, the two GNSS receivers arranged on the opposite sides of a train car are sufficiently separated for the purpose of detecting the multipath of received GNSS signals, are rigidly connected, e.g., through a body of the train, car, and, thus, always move with the same velocity.

Accordingly, one embodiment of the invention discloses a satellite navigation system. The navigation system includes a first GNSS receiver for determining a first value of a parameter of a GNSS signal; a second GNSS receiver for determining a second value of the parameter of the GNSS signal, wherein the first GNSS receiver is rigidly connected to the second GNSS receiver; and a processor for comparing the first value of the parameter with the second value of the parameter to detect a multipath of the GNSS signal.

Another embodiment discloses a method for determining a multipath signals received by a global navigation satellite system (GNSS). The method includes determining a first value of a parameter of a GNSS signal received by a first GNSS receiver; determining a second value of the parameter of the GNSS signal received by a second GNSS receiver, wherein the first GNSS receiver is rigidly connected to the second GNSS receiver; and comparing the first value of the parameter with the second value of the parameter to detect a multipath of the GNSS signal. The steps of the method are performed by a processor.

Yet another embodiment discloses a multipath detection system comprising a processor for comparing values of a parameter of global navigation satellite system (GNSS) signal received by different GNSS receivers and for detecting a multipath of the GNSS signal when the values of the parameter are different.

### BRIEF DESCRIPTION OF THE DRAWINGS

FIG. 1 is a schematic of a train car employing a global navigation satellite system (GNSS) to some embodiments of the invention;

FIG. 2 is a schematic of a GNSS receiver moving in a multi-path environment;

FIG. 3 is a schematic of a train having multiple cars entering a multipath-affected region from a multipath free region according to some embodiments of the invention;

FIG. 4 is a block diagram of a method for detecting a multipath of GNSS signals performed by a GNSS according to various embodiments of the invention;

FIG. 5 is an illustration of the Doppler Effect used by some embodiments of the invention;

FIG. 6 is a block diagram of a method for determining the frequency of a received GNSS signal using a phase-locked loop (PLL) according to one embodiment of the invention; and

FIG. 7 is a block diagram of a GNSS receiver according to one embodiment of the invention.

### DETAILED DESCRIPTION OF THE PREFERRED EMBODIMENTS

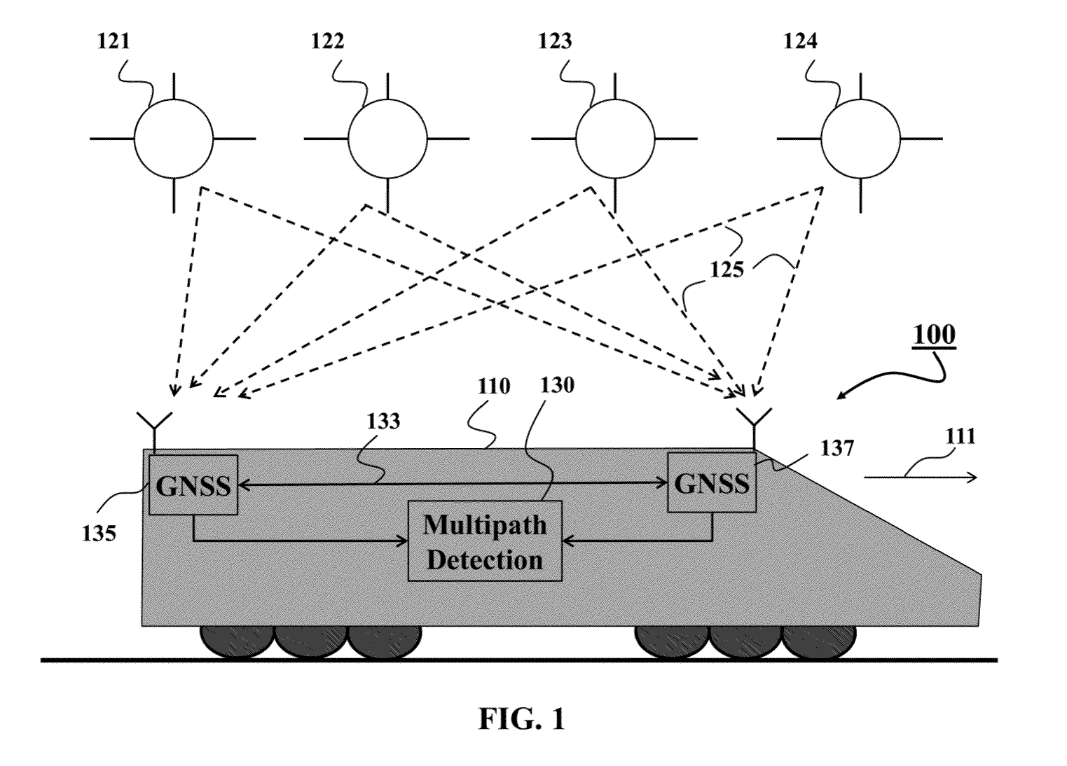

FIG. 1 shows a train car 110 employing a global navigation satellite system (GNSS) 100 according to some embodiments of the invention. The GNSS 100 includes a first GNSS receiver 135 and a second GNSS receiver 137. The first and the second GNSS receivers are rigidly connected to each other, in this embodiment, the first and the second GNSS receivers are arranged in the train car 110, and thus rigidly connected to each other through the body of the train car. In such a manner, the first and the second GNSS receivers can have identical velocity, i.e., the velocity of the train car 111. The first 135 and the second 137 GNSS receivers receive GNSS signals, e.g., the signals 125, from different GNSS satellites, such as satellites 121, 122, 123, and 124.

The GNSS 100 includes a multipath detection unit 130 for determining multipath of GNSS signals received from one or several satellites 121-124. Specifically, the GNSS receivers 135 and 137 determine parameters of the received signals 125, and the multipath detection unit 130 compares the values of the parameters to detect the multipath.

Some embodiments of the invention are based on a realization that if multiple GNSS receivers move with an identical velocity and are sufficiently spaced apart, then the parameters of the GNSS signals received by the GNSS receivers are similar if there is no multipath affecting the GNSS receivers, and different otherwise. Therefore, by comparing parameters of the GNSS signals received by multiple spatially separated GNSS receivers having the identical velocity, the multipath can be detected when a parameter of a GNSS signal received by one GNSS receiver differs from a parameter of the GNSS signal received by another GNSS receiver.

To that end, the first and the second GNSS receivers are spatially separated by a distance 133. For example, the receivers are arranged at two opposite ends of the train car 110. The embodiments of the invention can be installed in other types of vehicles or means of transportation, e.g., a vehicle, robot aircraft, or vessel. Usually, the GNSS receivers are spatially separated by a distance greater than a meter. Other variations of the distances are possible for different embodiments of the invention.

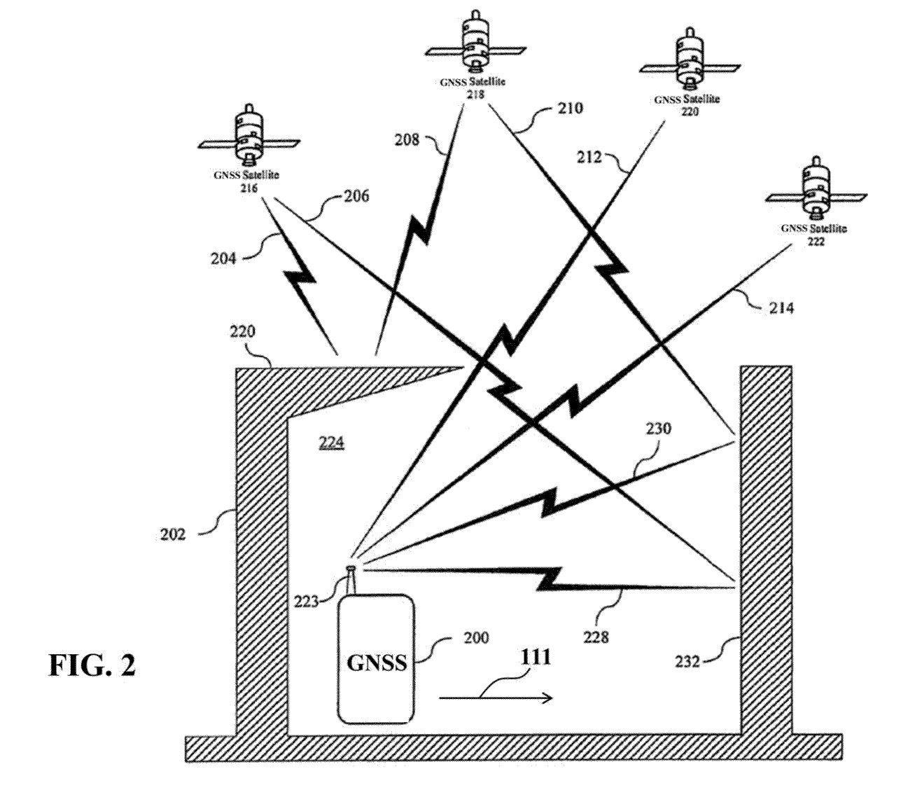

FIG. 2 shows a schematic of a GNSS receiver 200 moving 111 in a multi-path environment. The GNSS receiver 200 can be located in proximity with a structure 202 that partially blocks some to the GNSS signals 204, 206, 208, and 210 from GNSS satellites 216, and 218, respectively. The structure 202, as an example, may be a building, natural or man-made environmental structure, such as a canyon wall or street in a city with tall building. However, the structure 202 does not block the GNSS signals 212, and 214 from GNSS satellites 220, and 222. As the GNSS 200 moves, the combination of blocked and received GNSS signals from different satellites changes over time.

In this example, a GNSS antenna 223 receives signals from each GNSS satellite 216, 218, 220, and 222 via multiple paths reflected from the blockage or possible objects in the structure 202. The multi-path signals can result in constructive or destructive interference, with constructive interference increasing signal power and destructive interference reducing signal power. Generally, when the GNSS antenna 223 receives destructive multi-path interference, also known as “flat fading.” the signal cannot be recovered.

Specifically, as an example, GNSS signals 204 and 208 are blocked by part 220 of the structure 202 while GNSS signals 206, 210, 212, and 214 pass though free space 224. However, in this example, only GNSS signals 212 and 214 are directly received by GNSS receiver 200 while GNSS signals 206 and 210 are indirectly received by the GNSS receiver 200 via multi-path GNSS signals 226 and 228, respectively, that are reflected off of another structure 232.

Another possibility of multi-path propagation is a combination of a direct line-of-sight GNSS signal is available with reflected, non-line-of-sight or delayed version of that GNSS signal, in this case the two versions of the GNSS signal can potentially have different amplitudes, phases, and frequencies. Various embodiments if the invention is designed to detect the presence of any type of multipath GNSS signals.

Various embodiments of the invention avoid usage of multipath GNSS signals for satellite navigation because multipath GNSS signals give less accuracy and in satellite navigation, accuracy was and remains the prime goal. By comparing the parameters of the received GNSS signals, the embodiments can select the satellites with a direct line-of-sight (LOS) with the GNSS receivers and use the GNSS signals of only those satellites in GNSS navigation.

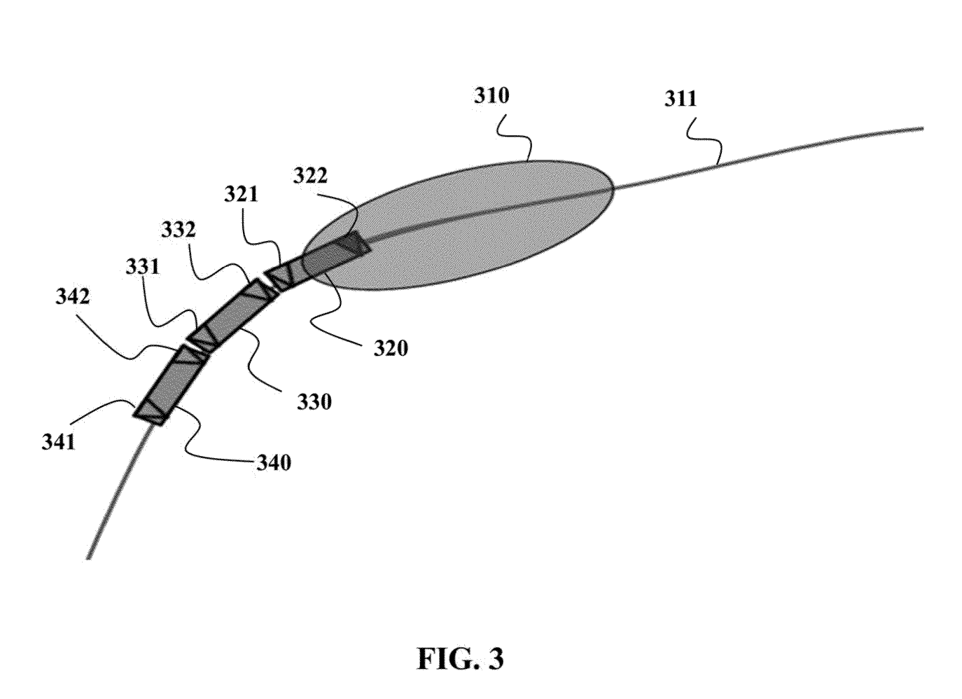

FIG. 3 shows a schematic of a train having multiple train cars 320, 330, and 340. The train moves along a path 311 entering a multipath-affected region 310 from a multipath free region. The triangles at various locations on the train represent different GNSS receivers. For example, the train car 320 has GNSS receivers 321 and 322. The train car 330 has GNSS receivers 331 and 332. The train car 340 has GNSS receivers 341 and 342. As the train enters the multipath-affected region 310, because the receivers 321 and 322 are spatially separated, the receiver 322 undergoes multipath effect, while the receiver 321 does not. In this example, the parameters of the GNSS signal received by the GNSS receivers 321 and 322 are different. Based on this understanding, various embodiments of the invention compare parameters of GPOS signals of rigidly connected GNSS receivers to detect the multipath.

Some embodiments of the invention is based on recognizing that there is a relationship between the vehicle and the environment in which the vehicle is operated. For example, in one embodiment, the two GNSS receivers are placed at both ends of a train car. This configuration is advantageous, because trains travel on tracks with much wider turning radii than, for example, cars or other terrestrial vehicles. Also, the train cars are tend to be longer than road vehicles and a large baseline between the two receivers favors the detection of multipath faults.

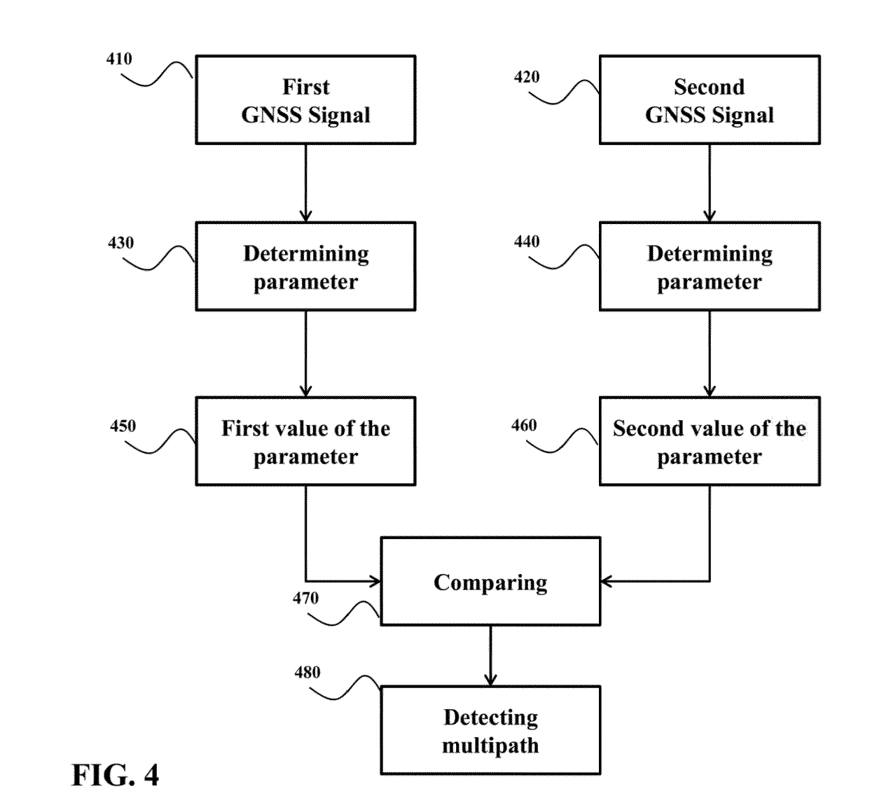

FIG. 4 shows a block diagram or a method for detecting multipath GNSS signals according to various embodiments of the invention. The first GNSS receiver, e.g., the GNSS receiver 135, determines 430 a first value of the parameter 450 of a first GNSS signal 410 transmitted by a GNSS satellite. The second GNSS receiver, e.g., the GNSS receiver 137, determines 440 a second value of the parameter 460 of a second GNSS signal 420 transmitted by the same GNSS satellite. The first and the second values are compared 470, e.g., using a processor of the multipath detection unit 130. The multipath is detected 480 when the first value 450 differs from the second value 460. For example, one embodiment determines a difference between the first and the second values of the parameter and detects the multipath if the difference is greater than a threshold.

Different embodiments of invention use different parameters of the GNSS signal to detect the multipath. For example, some embodiments use one or combination of amplitude, phase, frequency, or a rate of change of the frequency of the received signal, or a history of the frequencies over time, a signal to noise ratio (SNR), or the history of the signal to noise ratio over time. For example, in one embodiment, the parameter of the received signal is a frequency of the signal and/or deviation of the frequency from the nominal frequency of the GNSS signal. The actual frequency of the received GNSS signal deviates from this nominal value due to a Doppler shift, which is a consequence of the relative motion between the receiver and the satellite.

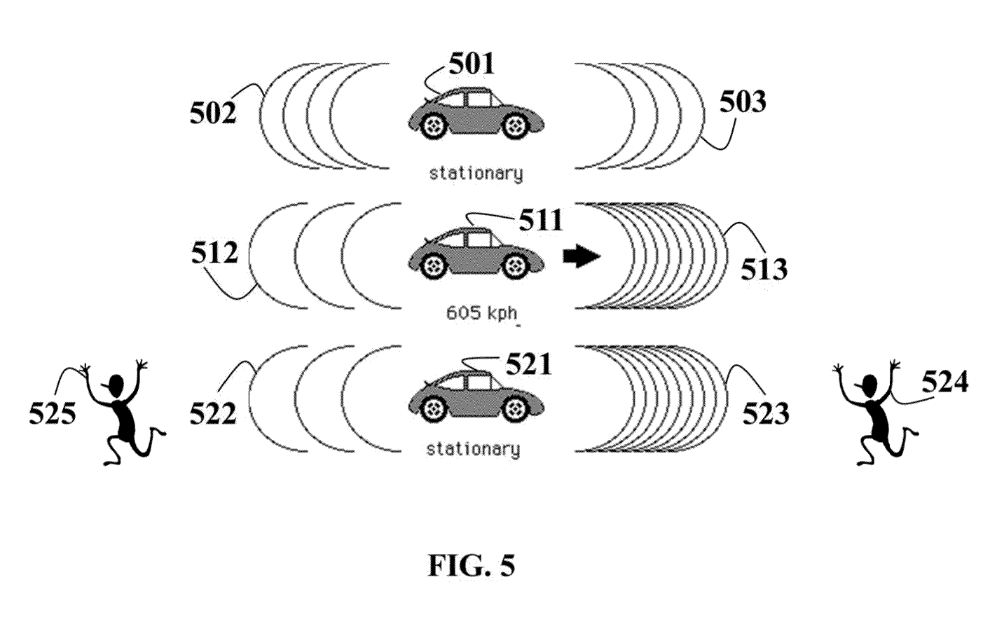

FIG. 5 shows an illustration of the Doppler frequency shift that appears because of a shortening or lengthening of the path of the GNSS signal. Electromagnetic, waves emitted from the car 101 propagate with the speed of light. To a stationary observer, the waves emitted by a stationary car 501 appear to have the same frequency, independent of the position of the observer, i.e., the waves 502 and 503 have the same frequency.

On the other hand, to a stationary observer, the waves emitted by a moving car 511 appear compressed 512 if the car is approaching the observer, and dilated 513 if the car is moving away from the observer. Similarly, if the car 521 is stationary but the observer is moving away 525 or toward 524 the car 521, the observed waves are compressed if the observer is approaching 524 the car and dilated if the observer is moving away 525 from the car.

Compression of the observed waves leads to a higher frequency of the received signal, compared to the original emitted signal. Conversely, the dilation leads to a lower received frequency.

In consequence, if the GNSS satellite and the GNSS receiver are moving towards each other, the received signal has a higher frequency than that of the emitted signal. Conversely, if the satellite is moving away from the receiver, the frequency of the received signal is lower than the nominal frequency. If a signal undergoes reflections on its path from the satellite to the GNSS receiver, a relative velocity between GNSS receiver and a reflector also induces a Doppler shift.

Accordingly, in one embodiment, the parameter of the GNSS signal is a frequency of the GNSS signal. This embodiment is advantageous, because in order to adequately decode the GNSS signal, the GNSS receivers need to determine the Doppler shift of the GNSS signals received from each satellite. As such, the frequency measurement is a by-product of the process by which the receiver determines its position, and the embodiment can use this by-product to detect the multipath.

Some embodiments use an assumption that GNSS satellites are thousands of kilometers from the GNSS receiver, but multipath reflections are close to the receiver, e.g., anywhere from meters to kilometers. Thus, signals that are not affected by multipath have similar characteristics, and signals that are affected by multipath differ in either power, frequency, or both.

In order to detect the presence of multipath, the processor tracks the relevant parameters for all receivers over time and detects discrepancies. Such discrepancies may manifest themselves as different signal powers on the same satellite signal, different frequencies, or a different behavior over time of either parameter.

As such, the parameters need to be estimated for each satellite signal at each receiver. Then for each satellite, the two received signals (410, 420) undergo identical processing to extract the relevant parameters (430, 440). In one embodiment of the invention, the parameters are signal frequency and/or signal power, as provided from a phase-locked loop in a GNSS receiver. The comparison between the two signals (470) can be almost instantaneous, or can be designed to accommodate recent values of the parameters.

One embodiment detects 480 the multipath, when the difference between the signal parameters exceeds a pre-defined finite (i.e., non-zero) error threshold. This embodiment takes into an account noisy measurements and estimates of the frequency.

This error threshold can be set by considering a desired false-alarm rate of the method and the expected noise level of the actual measurements. The false alarm rate is:

P_{FA}(x)=p(|x|>T|FALUT=FALSE),

where x>Tx>T indicates a detection, as the difference in measurements (x) exceeds the detection threshold (T), even though multi-path fault is not present. In one embodiment of the invention, the probability p(|x|>T|FALUT=FALSE) is Gaussian with a mean of zero, and the threshold can be computed in closed form as the inverse cumulative distribution of a Gaussian random variable with zero mean and a known standard deviation.

One embodiment performs the comparison using a tabulated error function (Φ) and its reciprocal (Φ^{—1}) in this embodiment, the false alarm rate is a function of the detection threshold and the standard deviation of the signal noise (σ):

$$T = {Φ}^{- 1} ( \frac{1 - {p}_{FA}}{2} ; 0 , σ ) .$$

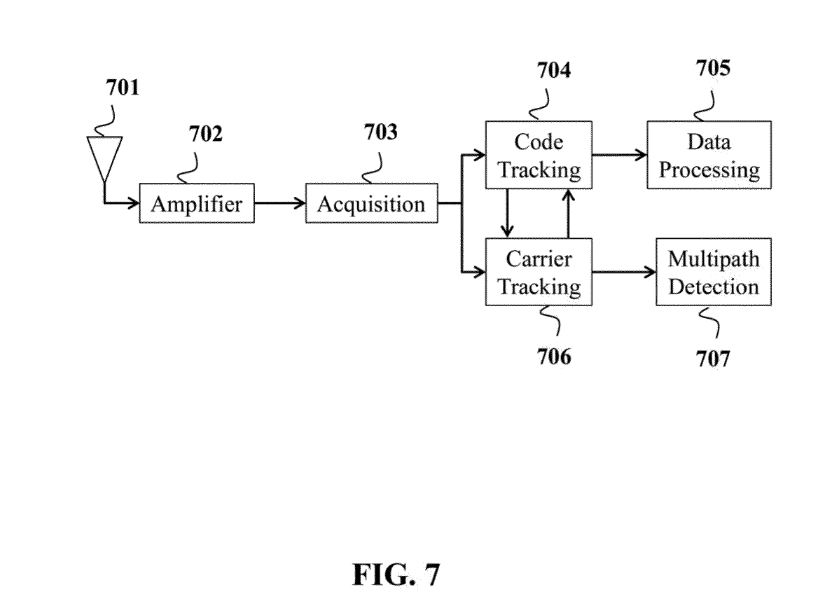

FIG. 7 shows a block diagram of a GNSS receiver used by some embodiments of the invention. The measurements required to detect the presence of multipath 707 are natively computed in the GNSS receiver as part of the process by which position is estimated. For example, an antenna 701 adapts the satellite signals from propagating through the air to propagating through the wiring of the receiver. After the antenna, and before acquisition, the received signal is made up of the sum of the signals emitted by each satellite. An amplifier 702 is designed to strengthen the signal for further processing. The acquisition 703 initializes the tracking process by supplying estimates for the phase and frequency of each received satellite signal. The tracking unit is tasked with estimating and providing measurements of the phase and frequency of each satellite signal over time for the carrier wave 706 and for code tracking 704. The code tracking 704 is used to determine and process 705 the data messages. The carrier wave tracking 706 is used to determine the multipath 707.

Some GNSS receivers can have several antennae for a single receiver, but combinations of several antennae with as many receivers are conceivable. One embodiment of this invention uses multiple antennae with as many receivers as antennae. The antennae are spatially separated, which allows the receivers to detect differences between the observed carrier frequencies on the same satellite signal.

The parameters compared in 430 and 440 can be estimated by the processor in the GNSS receiver. Both signal to noise ratio and signal frequency are determined for other purposes and re-used in monitoring multipath. In one embodiment of the invention, these parameters including received signal frequency and/or received signal power are derived from the tracking mechanism in the GNSS receiver.

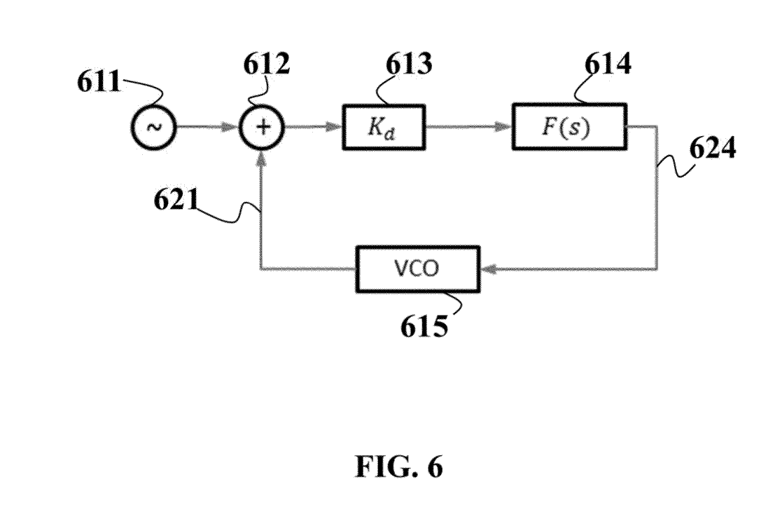

FIG. 6 shows a block diagram of a method for determining the frequency of a received GNSS signal using a phase-locked loop (PLL) according to one embodiment of the invention. The incoming GNSS signal at 611 is sinusoidal with time-dependent amplitude and phase. The phase detector 612 multiplies the GNSS signal 611 with a locally generated replica of the GNSS signal 621 generated by a voltage controlled oscillator (VCO) 615 such that the amplitude and a phase of the signal 621 eventually match the amplitude and the phase of the signal 611.

The multiplication 612 results in a signal 613 with a component at twice the frequency of the GNSS signal 611 and a baseband component proportional to the difference in phase between the signals 611 and 621. A low-pass filter 614 is removes the high-frequency components of the output 613 and the baseband component 624 is inputted to the VCO 615. If the phase of the signal 621 lags the phase of the signal 611, then the VCO increases the frequency of the signal 621 due to the baseband component 624. Conversely if the phase of the signal 621 leads the phase of the signal 611, then the frequency of the signal 621 is decreased. In such a manner, the known phase and/or frequency of the signal 621 match the phase and/or frequency of the signal 611 over time.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Also, the embodiments of the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit, and scope of the invention.

We claim:

1. A global navigation satellite system (GNSS), comprising:
a first GNSS receiver for determining a first value of a parameter of a GNSS signal;
a second GNSS receiver for determining a second value of the parameter of the GNSS signal, wherein the first GNSS receiver is rigidly connected to the second GNSS receiver; and
a processor for comparing the first value of the parameter with the second value of the parameter to detect a multipath of the GNSS signal.

2. The GNSS of claim 1, wherein the processor determines a difference between the first value and the second value and detects the multipath when the difference is greater than a threshold.

3. The GNSS of claim 2, wherein the threshold is determined using a false alarm probability.

4. The GNSS of claim 1, wherein the parameter of the GNSS signal is a frequency of the GNSS signal.

5. The GNSS of claim 1, wherein the parameter of the GNSS signal is the difference in frequency between the GNSS signals at each GNSS receiver.

6. The GNSS of claim 1, wherein the first and the second GNSS receivers determine values of the parameters of a set of GNSS signals received from a set of GNSS satellites, and wherein the processor selects a subset of satellites for a position estimation based on comparison of corresponding values of the parameters.

7. The GNSS of claim 1, wherein the first GNSS receiver is arranged at one side a train car, and the second GNSS receiver is arranged at an opposite side of the train car, such that the first GNSS receiver is rigidly connected to the second GNSS receiver through a body of the train car.

8. The GNSS of claim 1, wherein more than two receivers are rigidly linked together and the processor compares the values of their parameters of all of these to detect multipath.

9. The GNSS of claim 1, wherein the processor compares the values of more than one parameter to detect multipath.

10. The GNSS of claim 1, wherein the parameter of the GNSS signal is a time history of the frequency of a GNSS signal.

11. A method for determining a multipath signals received by a global navigation satellite system (GNSS) comprising:
determining a first value of a parameter of a GNSS signal received by a first GNSS receiver;
determining a second value of the parameter of the GNSS signal received by a second GNSS receiver, wherein the first GNSS receiver is rigidly connected to the second GNSS receiver; and
comparing the first value of the parameter with the second value of the parameter to detect a multipath of the GNSS signal, wherein steps of the method are performed by a processor.

12. The method of claim 1, further comprising:
determining a difference between the first value and the second value; and
detecting the multipath when the difference is greater than a threshold.

13. The method of claim 12, comprising:
determining the threshold using a false alarm probability.

14. The method of claim 11, wherein the parameter of the GNSS signal is a frequency of the GNSS signal.

15. The GNSS of claim 11, wherein the parameter of the GNSS signal is the difference in frequency between the GNSS signals at each GNSS receiver.

16. The method of claim 11, wherein the first and the second GNSS receivers determine values of the parameters of a set of GNSS signals received from a set of GNSS satellites, and wherein the processor selects a subset of satellites for a position estimation based on comparison of corresponding values of the parameters.

17. The method of claim 11, wherein the first GNSS receiver is arranged at one side of a train car, and the second GNSS receiver is arranged at an opposite side of the train car, such that the first GNSS receiver is rigidly connected to the second GNSS receiver through a body of the train car.

18. A multipath detection system comprising a processor for comparing values of a parameter of global navigation satellite system (GNSS) signal received by different GNSS receivers and for detecting a multipath of the GNSS signal when the values of the parameter are different.

19. The multipath detection system of claim 18, wherein the values include a first value of the parameter of the GNSS signal received by a first GNSS receiver and a second value of the parameter of the GNSS signal received by a second GNSS receiver, wherein the first GNSS receiver and the second GNSS receiver are moving with an identical velocity.

20. The multipath detection system of claim 18, wherein the parameter of the GNSS signal is a frequency of the GNSS signal.
